(19) United States
(12) Patent Application Publication
(10) Pub. No.: US 2009/0167861 A1
(43) Pub. Date: Jul. 2, 2009

(54) Observation System

(76) Inventor: Ehud Gal, Reut (IL)

Correspondence Address: ABELMAN, FRAYNE & SCHWAB, 666 THIRD AVENUE, 10TH FLOOR, NEW YORK, NY, 10017, US

(21) Appl. No.: 11/988,154

(22) PCT Filed: Jul. 13, 2006
(86) PCT No.: PCT/IL2006/000820

§ 371 Date: Dec. 27, 2007

(30) Foreign Application Priority Data
Jul. 13, 2005 (IL) 169655

(51) Int. Cl. H04N 7/18

(52) U.S. Cl. 348/143; 348/E07.085

(57) ABSTRACT

An operator-controllable observation system including an observation assembly including a housing having a generally ellipsoidal configuration with a flat base surface, an imaging subassembly including at least one lens coupled to at least one imaging sensor, control and processing circuitry operative to process outputs of the imaging subassembly and an observation assembly transceiver operative to receive outputs from the control and processing circuitry and to transmit the outputs from the control and processing circuitry.

### FIELD OF THE INVENTION

The present invention relates to mobile observation systems, and specifically to mobile observation systems having a self-stabilization capability and an extremely wide field of view.

### BACKGROUND OF THE INVENTION

The following published patent documents are believed to represent the current state of the art and the contents thereof are hereby incorporated by reference:

WO 2004/111673; WO 03/007258 and WO 03/046830.

### SUMMARY OF THE INVENTION

The present invention seeks to provide a mobile observation system having self-stabilization capabilities and an extremely wide field of view.

There is thus provided in accordance with a preferred embodiment of the present invention an operator-controllable observation system including an observation assembly including a housing having a generally ellipsoidal configuration with a flat base surface, an imaging subassembly including at least one lens coupled to at least one imaging sensor, control and processing circuitry operative to process outputs of the imaging subassembly and an observation assembly transceiver operative to receive outputs from the control and processing circuitry and to transmit the outputs from the control and processing circuitry.

In accordance with a preferred embodiment of the present invention the observation system also includes a control and display assembly including an input module, operative to allow the operator to provide operator inputs to the observation assembly, an output module operative to provide the outputs from the control and processing circuitry to the operator and an I/O transceiver operative to communicate with the observation assembly transceiver.

In accordance with another preferred embodiment of the present invention the housing is configured to have a center of gravity which is lower than a geometrical center of gravity of the housing, which is operative to provide rapid stabilization of the observation assembly on the flat base surface following introduction thereof into an operating environment. Preferably, the housing is stable on a flat horizontal surface only when the flat base surface lies on the flat horizontal surface. Additionally or alternatively, the housing is formed of a material which is at least one of shock-resistant, impact absorbent and transparent to RF radiation.

In accordance with yet another preferred embodiment of the present invention the at least one lens includes a lens having a circumferential field of view. Preferably, the housing includes a plurality of protrusions distributed about the lens, the plurality of protrusions being operative to protect the lens. Additionally or alternatively, the at least one lens includes a plurality of lenses, each having a regional field of view, the regional fields of view together defining a circumferential field of view around the observation assembly. Preferably, the plurality of lenses is recessed with respect to an outer surface of the housing.

In accordance with still another preferred embodiment of the present invention the imaging subassembly is operative to provide a real-time image of a circumferential field of view surrounding the observation assembly. Additionally, the observation assembly also includes an illumination subassembly including a plurality of illumination modules, operative to illuminate at least one field of view of the at least one lens. Preferably, the illumination subassembly is operative to provide uniform illumination to the at least one field of view.

In accordance with a further preferred embodiment of the present invention the observation assembly also includes a non-imaging sensor subassembly including at least one non-imaging sensor, the at least one non-imaging sensor including at least one of a microphone, a motion sensor, an electronic compass, an illumination sensor, a thermometer, a gas detector, a chemical detector, a radiation detector, a shock sensor, a timer and a location sensor.

In accordance with yet a further preferred embodiment of the present invention the illumination sensor is operative to sense an illumination level in at least one field of view of the at least one lens. Preferably, the microphone is operative to collect an audio signal from an operating environment of the observation assembly. Additionally or alternatively, at least one of the electronic compass and the location sensor is operative to sense a location of the observation assembly in global coordinates. Alternatively, the at least one of the electronic compass and the location sensor is operative to sense a location of the observation assembly relative to the control and display assembly.

In accordance with still another preferred embodiment of the present invention the control and processing circuitry is operative to process non-imaging sensor outputs of the at least one non-imaging sensor for transmission by the observation assembly transceiver to the I/O transceiver. Preferably, the output module is operative to display the non-imaging sensor outputs received by the I/O transceiver.

In accordance with an additional preferred embodiment of the present invention the observation assembly also includes a propulsion assembly employing an electric motor and at least one of wheels and caterpillar tracks. Preferably, the control and processing circuitry is operative to process the outputs of the imaging subassembly for transmission thereof by the observation assembly transceiver to the I/O transceiver.

In accordance with another preferred embodiment of the present invention, the output module includes at least one of a display and a speaker. Preferably, the display is operative to provide an image of a circumferential field of view surrounding the observation assembly to the operator.

In accordance with still another preferred embodiment of the present invention the I/O transceiver is operative to transmit the operator inputs to the control and processing circuitry via the observation assembly transceiver. Additionally or alternatively, the input module includes at least one of a keyboard, a touch screen, a pointing device, a microphone and a directional input device. Preferably, the directional input device is operative to be employed by the operator to provide movement instructions to the observation assembly.

In accordance with yet another preferred embodiment of the present invention the observation assembly transceiver and the I/O transceiver include wireless transceivers. Preferably, the observation assembly transceiver and the I/O transceiver communicate via an optical fiber.

There is also provided in accordance with another preferred embodiment of the present invention an operator-controllable observation system including:
at least one observation assembly including a housing having a generally ellipsoidal configuration with a flat base surface, an imaging subassembly including at least one lens coupled to at least one imaging sensor, control and processing circuitry operative to process outputs of the imaging subassembly and an observation assembly transceiver operative to receive outputs from the control and processing circuitry and to transmit the outputs from the control and processing circuitry, and
at least one control and display assembly including an input module, operative to allow the operator to provide operator inputs to the observation assembly, an output module operative to provide the outputs from the control and processing circuitry to the operator and an I/O transceiver operative to communicate with the observation assembly transceiver.

In accordance with a preferred embodiment of the present invention the at least one observation assembly includes a plurality of observation assemblies, the at least one control and display assembly includes a single control and display assembly and each of the plurality of observation assemblies is operative to communicate with the single control and display assembly. Preferably, at least one of the plurality of observation assemblies is also operative to communicate with at least one other of the plurality of observation assemblies via a network. Additionally or alternatively, the single control and display assembly includes processing circuitry operative to combine image outputs of the plurality of observation assemblies and to provide a combined representation of an operating environment of the plurality of observation assemblies to the operator.

In accordance with another preferred embodiment of the present invention the processing circuitry is operative to combine the image outputs of the plurality of observation assemblies by layering fields of the image outputs. Alternatively, the processing circuitry is operative to combine the image outputs of the plurality of observation assemblies by layering frames of the image outputs.

In accordance with yet another preferred embodiment of the present invention the at least one observation assembly includes a single observation assembly, the at least one control and display assembly includes a plurality of control and display assemblies and the single observation assembly is operative to communicate with each of the plurality of control and display assemblies, thereby relaying data between the plurality of control and display assemblies.

### BRIEF DESCRIPTION OF THE DRAWINGS

The present invention will be understood and appreciated more fully from the following detailed description, taken in conjunction with the drawings in which:

FIGS. 1A, 1B and 1C are simplified pictorial illustrations of the exterior of an observation assembly constructed and operative in accordance with a preferred embodiment of the present invention from three different perspectives;

FIGS. 2A, 2B and 2C are simplified pictorial illustrations of the interior of the observation assembly of FIGS. 1A-1C, from three different perspectives;

FIG. 3 is a simplified block diagram of an observation system including the observation assembly of FIGS. 1A-2C, constructed and operative in accordance with a preferred embodiment of the present invention;

FIG. 4 is a simplified pictorial illustration of the exterior of an observation assembly constructed and operative in accordance with another preferred embodiment of the present invention;

FIG. 5 is a simplified pictorial illustration of the interior of the observation assembly of FIG. 4; and

FIG. 6 is a simplified block diagram of an observation system including the observation assembly of FIGS. 4 and 5, constructed and operative in accordance with another preferred embodiment of the present invention.

### DETAILED DESCRIPTION OF PREFERRED EMBODIMENTS

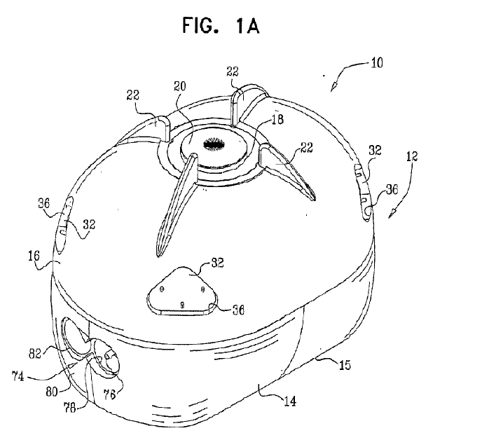

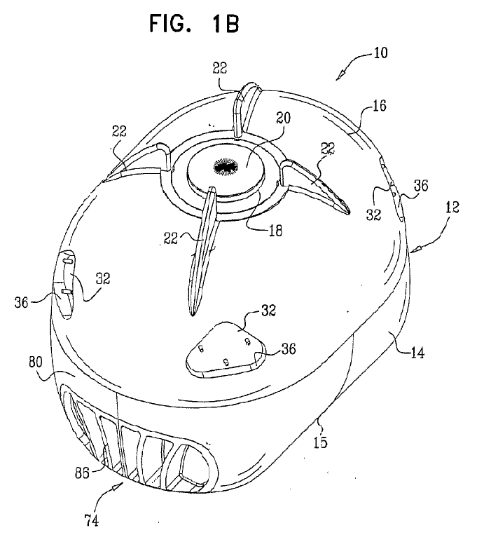

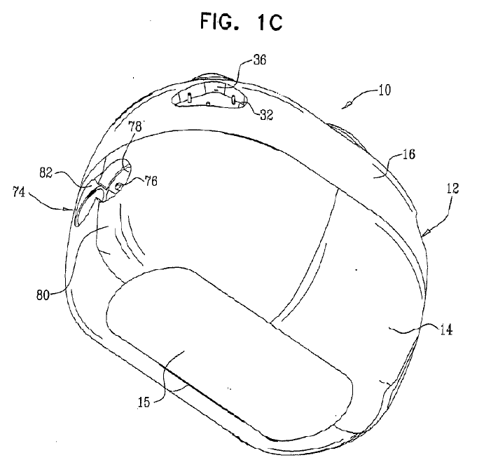

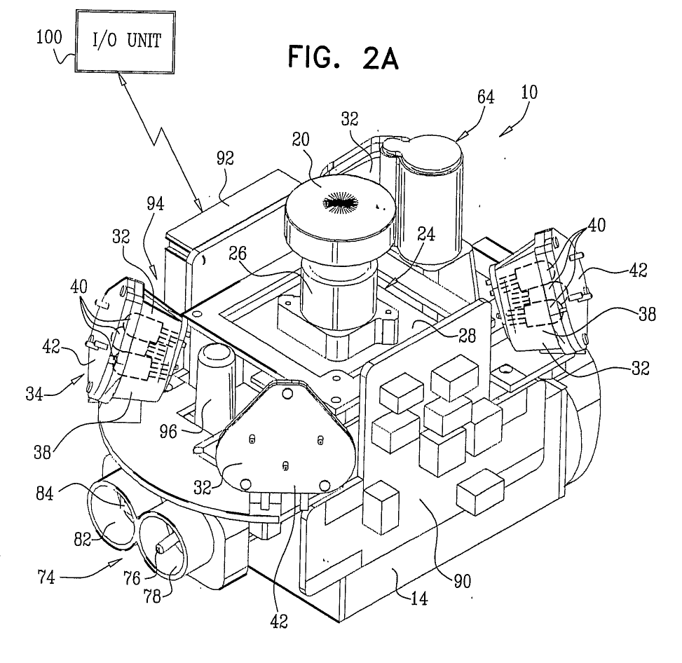

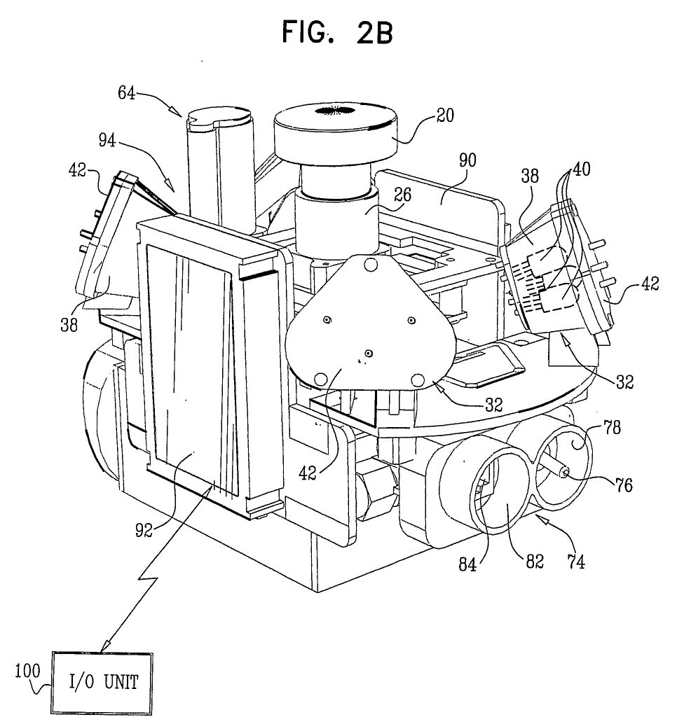

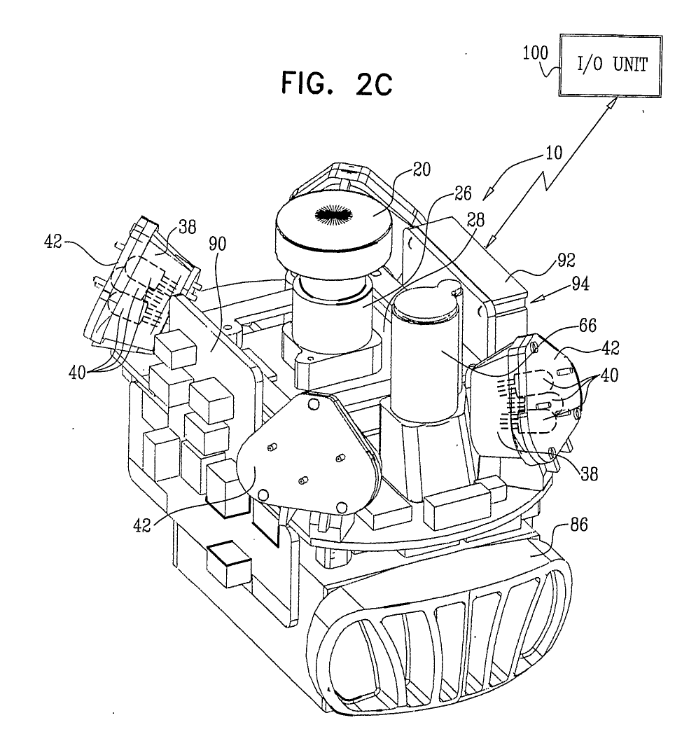

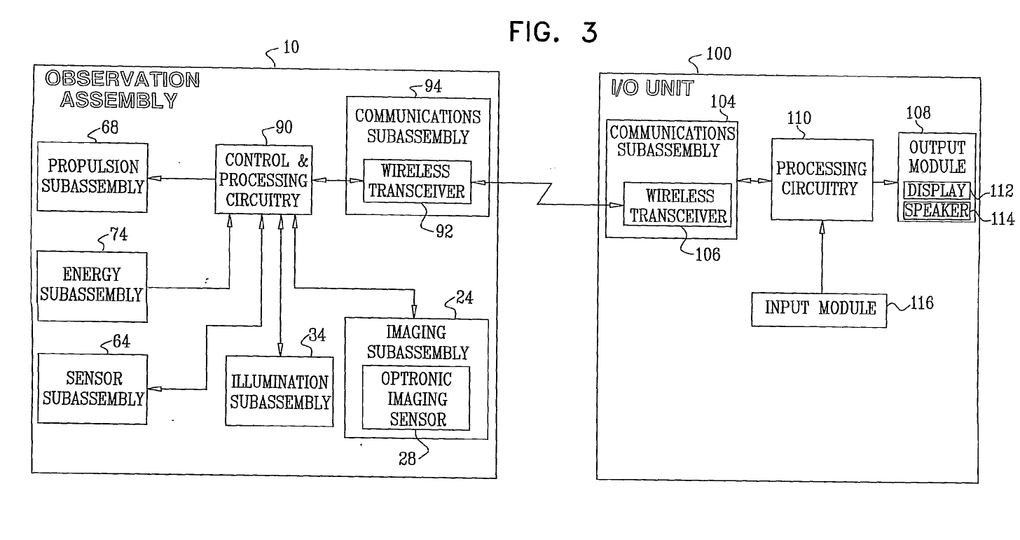

Reference is now made to FIGS. 1A, 1B and 1C, which are simplified pictorial illustrations of the exterior of an observation assembly constructed and operative in accordance with a preferred embodiment of the present invention, from three different perspectives, to FIGS. 2A, 2B and 2C, which are simplified pictorial illustrations of the interior of the observation assembly of FIGS. 1A-1C, and to FIG. 3, which is a simplified block diagram of an observation system including the observation assembly of FIGS. 1A -2C, constructed and operative in accordance with a preferred embodiment of the present invention.

The observation assembly shown in FIGS. 1A-2C is operative to collect data from an operating environment and to transmit the collected data to an external output unit, which is typically located remotely from the observation assembly and which is accessible to an operator. The observation assembly may be thrown, launched or otherwise introduced into the operating environment. The observation assembly of FIGS. 1A-2C is particularly suitable for collection and transmission of data in a dangerous or otherwise inaccessible environment.

As seen in FIGS. 1A, 1B and 1C, an observation assembly 10 has an overall ellipsoidal configuration having a flat base. The observation assembly 10 preferably comprises a housing 12, including a base portion 14, defining a flat base surface 15, and a cover portion 16. The observation assembly 10 is also configured to have a center of gravity which is lower than its geometrical center.

The housing 12 may be integrally formed over internal components of the observation assembly 10, described hereinbelow, by molding the housing 12 onto the internal components. Alternatively, housing 12 may be a multi-element housing, including individually formed elements, such as base portion 14 and cover portion 16, which may be attached to one another.

Turning specifically to FIG. 1C, it is seen that the flat base surface 15 preferably has an elliptical configuration and is particularly suitable for providing particularly rapid stabilization of the assembly following introduction thereof into the operating environment. The geometrical structure of housing 12 and particularly of base 14 is characterized in that it is not stable on a flat horizontal surface other than when flat base surface 15 lies on the flat surface. The location of the center of gravity of observation assembly 10 reduces the time duration from introduction of the observation assembly 10 to stabilization thereof.

Housing 12 is preferably formed of a rigid material, such as polyurethane, and is preferably shock-resistant and/or impact-absorbent. Additionally, the housing 12 enables optimal protection of the internal components of the observation assembly 10 from impact damage, which may occur during or after introduction of the observation assembly 10 to its operating environment. The housing 12 also provides heat dissipation and is transparent to RF communication.

As seen in FIGS. 1A and 1B, cover portion 16 is preferably formed with a generally circular aperture 18, which accommodates a lens 20, having a circumferential field of view. Surrounding aperture 18, and generally uniformly spaced therearound, there are preferably formed a plurality of protrusions 22, which protrude from cover portion 16 to a greater extent than does lens 20. Accordingly, protrusions 22 are operative to protect the lens 20 from direct impact when the assembly 10 lands upside-down on a flat surface.

As seen in FIGS. 2A-2C, an imaging subassembly 24 includes the circumferential lens 20, such as a Fish-Eye Lens, commercially available from Omnitech Robotics LLC of Colorado, USA, which is mounted via an adapter 26 onto an imaging sensor 28, such as CCD Color Camera, commercially available from Mintron Enterprise Co. LTD. of Taipei, Taiwan. Circumferential lens 20, together with imaging sensor 28, is operative to provide a real-time image of the circumferential field of view about the lens 20.

Returning to FIGS. 1A-1C, it is seen that a plurality of illumination modules 32, together comprising an illumination subassembly 34, are preferably located in recesses 36 distributed on cover portion 16 about lens 20. Illumination modules 32 are operative to illuminate the circumferential field of view about lens 20. Preferably, four illumination modules 32 are provided, each arranged at one corner of imaging sensor 28. As seen in FIGS. 2A-2C, each of illumination modules 32 preferably includes a LED housing base 38, a plurality of LEDs 40, typically three in number, and a transparent LED housing cover 42.

The illumination subassembly 34 is operative to provide illumination in wavelengths suitable for optimal operation of the imaging sensor 28. Such illumination is typically provided when background illumination in the operating environment of the observation assembly 10 is insufficient. The illumination provided by the illumination subassembly 34 may be circumferential or directional, and may be uniform throughout the illuminated area or may vary in different regions thereof. The illumination subassembly 34 may be automatically, semi-automatically or manually activated, and the activation method may be preset by an operator.

A non-imaging sensor subassembly 64 preferably forms part of the observation assembly 10, and preferably includes one or more of a microphone, a motion sensor, an electronic compass, an illumination sensor, a thermometer, a gas detector, a chemical detector, a radiation detector, a shock sensor, a timer, and a location sensor, such as a GPS location sensor.

The sensors included in non-imaging sensor subassembly 64 are operative to collect information from the operating environment of the observation assembly 10.

The illumination sensor of sensor subassembly 64 is preferably operative to sense the illumination level in the operating environment, and to automatically activate the illumination modules 32 of illumination subassembly 34 if the illumination in the operating environment is insufficient for operation of the imaging subassembly 24.

The microphone of sensor subassembly 64 is preferably operative to collect an audio signal from the operating environment of the observation assembly 10. The electronic compass and/or location sensor of sensor subassembly 64 is operative to determine the exact location of the observation assembly 10 in global coordinates or with reference to a reference location, such as a location of an operator. The timer of sensor subassembly 64 enables an operator to select specific times at which the various sensors of observation assembly 10 will sense and/or measure specific parameters of the operating environment.

Optionally, a propulsion subassembly 68, typically employing an electric motor (not shown) and including wheels or caterpillar tracks (not shown), may be included in observation assembly 10. The propulsion assembly 68 is operative to facilitate movement of the observation assembly 10, in response to control commands provided to the observation assembly 10. As a further option, the observation assembly 10 may include a speaker (not shown), which is operative to allow transmission of sound.

An energy subassembly 74 preferably comprises an activation switch 76, which is preferably located within a recess 78 formed on a side 80 of base portion 14. Adjacent recess 78, and preferably in touching engagement therewith, there is provided an additional recess 82 in which is located a recharger connector 84.

Energy subassembly 74 may also comprise a removable battery enclosure 86, which is preferably provided on a side 88 of base portion 14 opposite recesses 78 and 82. Battery enclosure 86 preferably includes rechargeable batteries (not shown) which provide power to imaging subassembly 24, illumination subassembly 34, non-imaging sensor subassembly 64 and propulsion subassembly 68.

As seen with particular clarity in FIG. 3, the observation assembly 10 also includes control and processing circuitry 90, which is operative to control, activate and operate the imaging subassembly 24, illumination subassembly 34, non-imaging sensor subassembly 64, propulsion assembly 68 and energy subassembly 74. The control and processing circuitry 90 preferably also controls various parameters of the imaging subassembly 24, such as the required sensitivity for specific illumination levels.

Preferably, the control and processing circuitry 90 receives the data collected by imaging sensor 28 and by the sensors of non-imaging sensor subassembly 64, and process the data for transmission in analog or digital format.

Control and processing circuitry 90 preferably provides the processed data to a transceiver 92 which preferably is mounted adjacent lens 20, and forms part of a communications subassembly 94, which also includes an antenna 96. Communications subassembly 94 is operative to transmit data and images, collected by imaging sensor 28 and the sensors of non-imaging sensor subassembly 64 of the observation assembly 10, to an external I/O unit 100, which is accessible by an operator.

As seen with particular clarity in FIG. 3, I/O unit 100 preferably comprises a communications subassembly 104 including a transceiver 106, which is operative to communicate with transceiver 92 of the observation assembly 10 and to receive the data collected by the sensors of observation assembly 10. The data received by transceiver 106 is preferably provided to an output module 108 via processing circuitry 110.

In accordance with the illustrated embodiment, transceivers 92 and 106 are wireless transceivers, operative to wirelessly communicate with one another.

In an alternative embodiment of the present invention, the information collected by imaging sensor 28 and by the sensors of non-imaging sensor subassembly 64 is provided to the output module 108 of I/O unit 100 via an optical fiber (not shown). The optical fiber may be coiled inside observation assembly 10, such that the fiber uncoils as a result of movement of the observation assembly 10, such as when the observation assembly 10 is introduced into the operating environment. In this embodiment, the transceivers 92 and 106 are operative to communicate with one another via the optical fiber.

Output module 108 preferably includes a display 112 and a speaker 114. Preferably, a circumferential image of the operating environment, as collected by imaging sensor 28, is provided on display 112. Preferably, data collected by the sensors of non-imaging sensor subassembly 64, such as the temperature in the operating environment, the presence of gasses, chemicals or radiation in the operating environment and the battery charge level of the observation assembly are also provided to an operator via output module 108.

Transceiver 106 is also operative to transmit commands, received from an operator via an input module 116 and processing circuitry 110, to transceiver 92 of observation assembly 10.

Input module 116 preferably includes at least one input device, such as a keyboard, a touch screen, a pointing device and/or a microphone. Optionally, the input module 116 also includes a directional input device (not shown), such as an arrow pad, which may be employed by an operator to provide commands to propulsion subassembly 68 and thereby to move or relocate the observation subassembly 10.

In accordance with one embodiment of the present invention, the I/O unit 100 may communicate with a plurality of observation assemblies 10, which also may communicate with each other via a network (not shown). When plural observation assemblies 10 are employed, the processing circuitry 110 preferably combines inputs received from each of the observation assemblies 10 and provides to output module 102 a combined representation of the operating environment.

Preferably, processing circuitry 110 provides the combined representation by layering frames or fields of images received from the various observation assemblies 10. Preferably, each of the layered frames or fields is annotated, so as to indicate its origin.

In accordance with another preferred embodiment of the present invention, one observation assembly 10 may provide data to plural I/O units 100, thus functioning as a relay between the I/O units 100.

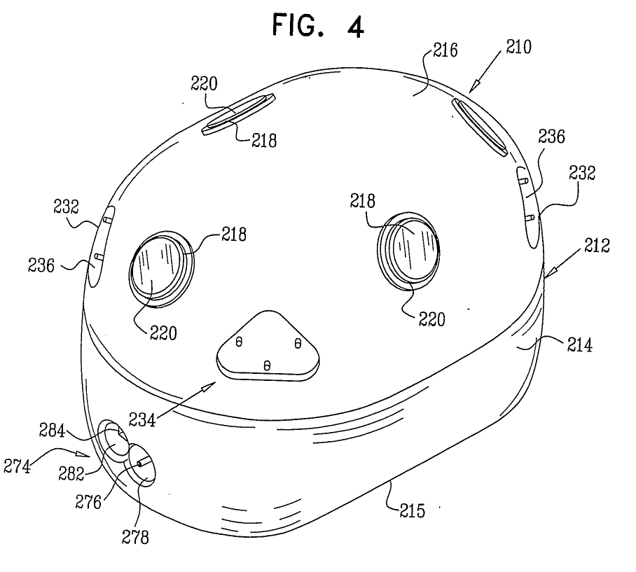

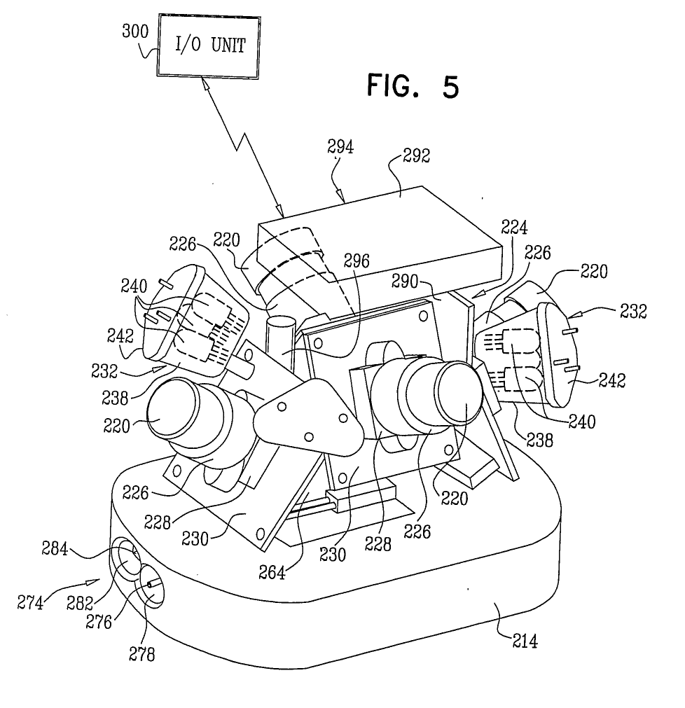

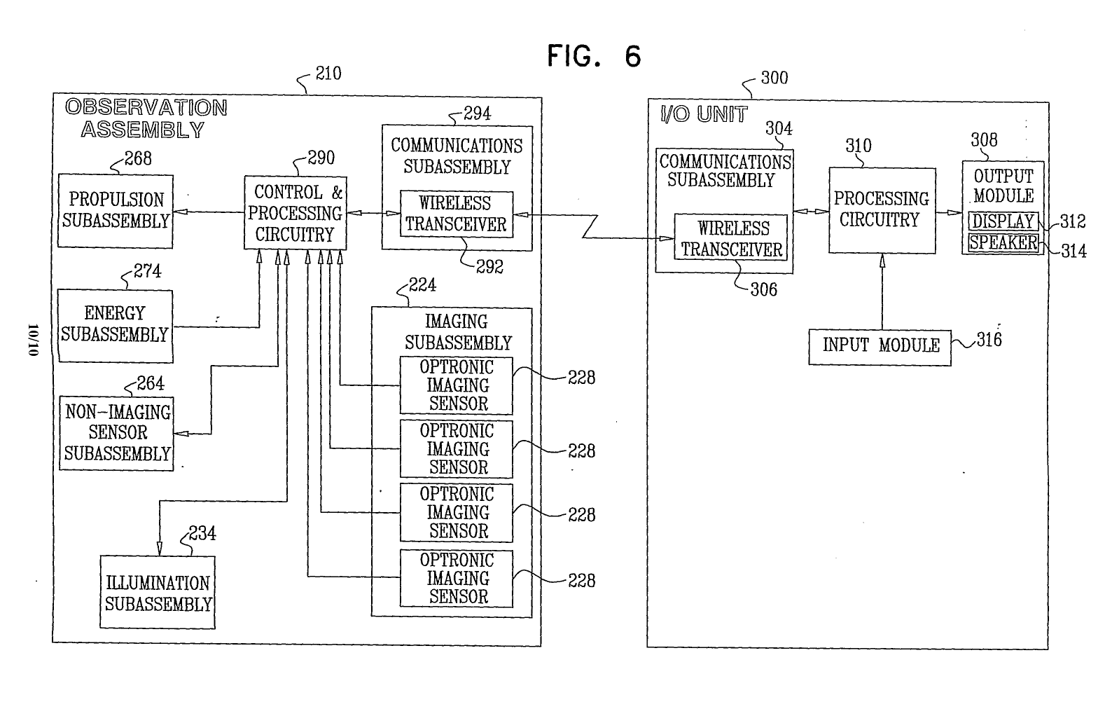

Reference is now made to FIG. 4, which is a simplified pictorial illustration of the exterior of an observation assembly constructed and operative in accordance with another preferred embodiment of the present invention, to FIG. 5, which is a simplified pictorial illustration of the interior of the observation assembly of FIG. 4, and to FIG. 6, which is a simplified block diagram of an observation system including the observation assembly of FIGS. 4 and 5, constructed and operative in accordance with another preferred embodiment of the present invention.

The observation assembly shown in FIGS. 4 and 5 is operative to collect data from an operating environment and to transmit the collected data to an external output unit, which is typically located remotely from the observation assembly and which is accessible to an operator. The observation assembly may be thrown, launched or otherwise introduced into the operating environment. The observation assembly of FIGS. 4 and 5 is particularly suitable for collection and transmission of data in a dangerous or otherwise inaccessible environment.

As seen in FIG. 4, an observation assembly 210 has an overall ellipsoidal configuration having a flat base. The observation assembly 210 preferably has a multi-element housing 212, including a base portion 214, defining a flat base surface 215, and a cover portion 216. The observation assembly 210 is also configured to have a center of gravity which is lower than its geometrical center.

The housing 212 may be integrally formed over internal components of the observation assembly 210, described hereinbelow, by molding the housing 212 onto the internal components. Alternatively, housing 212 may be a multi-element housing, including individually formed elements, such as base portion 214 and cover portion 216, which may be attached to one another.

Flat base surface 215 preferably has an elliptical configuration and is particularly suitable for providing particularly rapid stabilization of the assembly following introduction thereof into the operating environment. The geometrical structure of housing 212 and particularly of base 214 is characterized in that it is not stable on a flat horizontal surface other than when flat base surface 215 lies on the flat surface. The center of gravity of observation assembly 210 reduces the time duration from introduction of the observation assembly 210 to stabilization thereof.

Housing 212 is preferably formed of a rigid material, such as polyurethane, and is preferably shock-resistant and/or impact-absorbent. Additionally, the housing 212 enables optimal protection the internal components of the observation assembly 210 from impact damage, which may occur during or after introduction of the observation assembly 210 to its operating environment. The housing 212 also provides heat dissipation and is transparent to RF communication.

As seen in FIG. 4, cover portion 216 is preferably formed with a plurality of generally circular apertures 218, each having a lens 220, having a regional field of view, recessed therein. Preferably, four lenses 220 are generally uniformly distributed around cover portion 216.

As seen in FIG. 5, an imaging subassembly 224 includes the lenses 220, each of which is mounted via an adapter 226 onto an imaging sensor 228, such as CCD Color Camera, commercially available from Mintron Enterprise Co. LTD. of Taipei, Taiwan. The imaging sensors 228 are preferably configured in a generally pyramidal structure. Lenses 220, together with imaging sensors 228, are operative to provide a real-time image of a circumferential field of view about the observation assembly 210.

Returning to FIG. 4, it is seen that a plurality of illumination modules 232, together comprising an illumination subassembly 234, are preferably located in recesses 236 distributed on cover portion 216. Preferably, four illumination modules 232 are provided. Illumination modules 232 are operative to illuminate a circumferential field of view about observation assembly 210. As seen in FIG. 5, each of illumination modules 232 preferably includes a LED housing base 238, a plurality of LEDs 240, typically three in number, and a transparent LED housing cover 242.

The illumination subassembly 234 is operative to provide illumination in wavelengths suitable for optimal function of the imaging sensors 228. Such illumination is typically provided when background illumination in the operating environment of the observation assembly 210 is insufficient. The illumination provided by the illumination subassembly 234 may be circumferential or directional, and may be uniform throughout the illuminated area or may vary in different regions thereof. The illumination subassembly 234 may be automatically, semi-automatically or manually activated, and the activation method may be preset by an operator.

A non-imaging sensor subassembly 264 Preferably forms part of the observation assembly 210 and preferably includes one or more of a microphone, a motion sensor an electronic compass, an illumination sensor, a thermometer, a gas detector, a chemical detector, a radiation detector, a shock sensor, a timer and a location sensor, such as a GPS location sensor.

The sensors included in non-imaging sensor subassembly 264 are operative to collect information from the operating environment of the observation assembly 210.

The illumination sensor of sensor subassembly 264 is preferably operative to sense the illumination level in the operating environment, and to automatically activate the illumination modules 232 of illumination subassembly 234 if the illumination in the operating environment is insufficient for function of the imaging subassembly 224.

The microphone of sensor subassembly 264 is preferably operative to collect an audio signal from the operating environment of the observation assembly 210. The electronic compass and/or location sensor of sensor subassembly 264 is operative to determine the exact location of the observation assembly 210 in global coordinates or with reference to a reference location, such as a location of an operator. The timer of sensor subassembly 264 enables an operator to select specific times at which the various sensors of observation assembly 210 will sense and/or measure specific parameters of the operating environment.

Optionally, a propulsion subassembly 268, typically employing an electric motor (not shown) and including wheels or caterpillar tracks (not shown), may be included in observation assembly 210. The propulsion assembly 268 is operative to facilitate movement of the observation assembly 210, in response to control commands provided to the observation assembly 210. As a further option, the observation assembly 210 may include a speaker (not shown) which is operative to allow transmission of sound.

An energy subassembly 274 preferably comprises an activation switch 276, which is preferably located within a recess 278 formed on a side 280 of base portion 214. Adjacent recess 278, and preferably in touching engagement therewith, there is provided an additional recess 282 in which is located a recharger connector 284.

Energy subassembly 274 may also comprise a removable battery enclosure (not shown), which is preferably provided on a side of base portion 214 opposite recesses 278 and 282. The battery enclosure preferably includes rechargeable batteries (not shown) which provide power to imaging subassembly 224, illumination subassembly 234, non-imaging sensor subassembly 264 and propulsion subassembly 268.

As seen with particular clarity in FIG. 6, the observation assembly 210 also includes control and processing circuitry 290, which is operative to control, activate and operate the imaging subassembly 224, illumination subassembly 234, non-imaging sensor subassembly 264, propulsion subassembly 268 and energy subassembly 274. The control and processing circuitry 290 preferably also controls various parameters of the imaging subassembly 224, such as the required sensitivity for specific illumination levels.

Preferably, the control and processing circuitry 290 receives the data collected by imaging sensors 228 and by the sensors of non-imaging sensor subassembly 264, and process the data for transmission in analog or digital format. The control and processing circuitry 290 may process the data received from one or more of imaging sensors 228. Preferably, the control and processing circuitry 290 combines the data received from the imaging sensors 228 to provide circumferential image of a field of view surrounding observation assembly 210.

Control and processing circuitry 290 preferably provides the processed data to a transceiver 292, which preferably is mounted above imaging sensors 228 onto an underside of cover portion 216, and forms part of a communications subassembly 294, which also includes an antenna 296. Communications subassembly 294 is operative to transmit data and images, collected by imaging sensors 228 and the sensors of non-imaging sensor subassembly 264 of the observation assembly 210, to an external I/O unit 300, which is accessible by an operator.

If the data from each of the imaging sensors 228 is not combined by control and processing circuitry to provide a circumferential image, the transmission of the data received from the imaging sensors 228 is preferably carried out by overlaying fields or frames, it being possible to control the relative portions in the transmission of the fields or frames received from each of the imaging sensors 228.

As seen with particular clarity in FIG. 6, I/O unit 300 preferably comprises a communications subassembly 304 including a transceiver 306, which is operative to communicate with transceiver 292 of the observation assembly 210, and to receive the data collected by the sensors of observation assembly 210. The data received by transceiver 306 is preferably provided to an output module 308 via processing circuitry 310.

In accordance with the illustrated embodiment, transceivers 292 and 306 are wireless transceivers, operative to wirelessly communicate with one another.

In an alternative embodiment of the present invention, the information collected by imaging sensors 228 and by the sensors of non-imaging sensor subassembly 264 is provided to the output module 308 of I/O unit 300 via an optical fiber (not shown). The optical fiber may be coiled inside observation assembly 210, such that the fiber uncoils as a result of movement of the observation assembly 210, such as when the observation assembly 210 is introduced into the operating environment. In this embodiment, transceivers 292 and 306 are operative to communicate with one another via the optical fiber.

If the data from each imaging sensors 228 is not combined by control and processing circuitry 290, processing circuitry 310 provides a circumferential image of a field of view surrounding observation assembly 210 by correcting distortions and perspective in the signal received from each of the imaging sensors 228, and stitching the corrected images together.

Output module 308 preferably includes a display 312 and a speaker 314. Preferably, a circumferential image of the operating environment, as collected by imaging sensors 228, is provided on display 312.

Preferably, data collected by the sensors of non-imaging sensor subassembly 264, such as the temperature in the operating environment, the presence of gasses, chemicals or radiation in the operating environment and the battery charge level of the observation assembly are also provided to an operator via output module 308.

Transceiver 306 is also operative to transmit commands, received from an operator via an input module 316 and processing circuitry 310, to transceiver 292 of observation assembly 210.

Input module 316 preferably includes at least one input device such as a keyboard, a touch screen, a mouse and/or a microphone. Optionally, the input module 316 also includes a directional input device (not shown), such as an arrow pad, which may be employed by an operator to provide commands to propulsion subassembly 268 and thereby to move or relocate the observation subassembly 210.

In accordance with one embodiment of the present invention, the I/O unit 300 may communicate with a plurality of observation assemblies 210, which may communicate with each other via a network (not shown). When plural observation assemblies 210 are employed, the processing circuitry 310 preferably combines inputs received from each of the observation assemblies 210 and provides to output module 302 a combined representation of the operating environment.

Preferably, processing circuitry 310 provides the combined representation by layering frames or fields of images received from the various observation assemblies 210. Preferably, each of the layered frames or fields is annotated, so as to indicate its origin.

In accordance with another preferred embodiment of the present invention, one 20, observation assembly 210 may provide data to plural I/O units 300, thus functioning as a relay between the WO units 300.

It is appreciated that the imaging subassembly described hereinabove with reference to FIGS. 1A-3, may be incorporated into the observation assembly 210 of FIGS. 4-6.

It will be appreciated by persons skilled in the art that the present invention is not limited by what has been particularly shown and described hereinabove. Rather the scope of the present invention includes combinations and subcombinations of various features described hereinabove as well as modifications thereof which would occur to a person skilled in the art upon reading the foregoing description, and which are not in the prior art.

1. An operator-controllable observation system comprising:
an observation assembly including:
a housing having a generally ellipsoidal configuration with a flat base surface;
an imaging subassembly including at least one lens coupled to at least one imaging sensor;
control and processing circuitry operative to process outputs of said imaging subassembly; and
an observation assembly transceiver operative to receive outputs from said control and processing circuitry and to transmit said outputs from said control and processing circuitry.

2. An operator-controllable observation system according to claim 1, and also comprising a control and display assembly including:
an input module, operative to allow said operator to provide operator inputs to said observation assembly;
an output module operative to provide said outputs from said control and processing circuitry to said operator; and
an I/O transceiver operative to communicate with said observation assembly transceiver.

3. An operator-controllable observation system according to claim 1, wherein said housing is configured to have a center of gravity which is lower than a geometrical center of gravity of said housing, which is operative to provide rapid stabilization of said observation assembly on said flat base surface following introduction thereof into an operating environment.

4. An operator-controllable observation system according to claim 1, wherein said housing is stable on a flat horizontal surface only when said flat base surface lies on said flat horizontal surface.

5. An operator-controllable observation system according to claim 1 and wherein said housing is formed of a material which is at least one of shock-resistant, impact absorbent and transparent to RF radiation.

6. An operator-controllable observation system according to claim 1, wherein said at least one lens comprises a lens having a circumferential field of view.

7. An operator-controllable observations system according to claim 6, wherein said housing comprises a plurality of protrusions distributed about said lens, said plurality of protrusions being operative to protect said lens.

8. An operator-controllable observation system according to claim 1, wherein said at least one lens comprises a plurality of lenses, each having a regional field of view, the regional fields of view together defining a circumferential field of view around said observation assembly.

9. An operator-controllable observation system according to claim 8, wherein said plurality of lenses is recessed with respect to an outer surface of said housing.

10. An operator-controllable observation system according to claim 1, wherein said imaging subassembly is operative to provide a real-time image of a circumferential field of view surrounding said observation assembly.

11. An operator-controllable observation system according to claim 1, wherein said observation assembly also includes an illumination subassembly comprising a plurality of illumination modules, operative to illuminate at least one field of view of said at least one lens.

12. An operator-controllable observation system according to claim 11, wherein said illumination subassembly is operative to provide uniform illumination to said at least one field of view.

13. An operator-controllable observation system according to claim 2, wherein said observation assembly also comprises a non-imaging sensor subassembly including at least one non-imaging sensor, said at least one non-imaging sensor comprising at least one of a microphone, a motion sensor, an electronic compass, an illumination sensor, a thermometer, a gas detector, a chemical detector, a radiation detector, a shock sensor, a timer and a location sensor.

14-17. (canceled)

18. An operator-controllable observation system according to claim 13, wherein said control and processing circuitry is operative to process non-imaging sensor outputs of said at least one non-imaging sensor for transmission by said observation assembly transceiver to said I/O transceiver.

19. An operator-controllable observation system according to claim 18, wherein said output module is operative to display said non-imaging sensor outputs received by said I/O transceiver.

20. An operator-controllable observation system according to claim 1, wherein said observation assembly also comprises a propulsion assembly employing an electric motor and at least one of wheels and caterpillar tracks.

21. An operator-controllable observation system according to claim 2, wherein said control and processing circuitry is operative to process said outputs of said imaging subassembly for transmission thereof by said observation assembly transceiver to said I/O transceiver.

22. An operator-controllable observation system according to claim 2, wherein said output module comprises at least one of a display and a speaker.

23. An operator-controllable observation system according to claim 22, wherein said display is operative to provide an image of a circumferential field of view surrounding said observation assembly to said operator.

24. An operator-controllable observation system according to claim 2, wherein said I/O transceiver is operative to transmit said operator inputs to said control and processing circuitry via said observation assembly transceiver.

25. An operator-controllable observation system according to claim 2, wherein said input module comprises at least one of a keyboard, a touch screen, a pointing device, a microphone and a directional input device.

26. An operator-controllable observation system according to claim 25, wherein said directional input device is operative to be employed by said operator to provide movement instructions to said observation assembly.

27. An operator-controllable observation system according to claim 2, wherein said observation assembly transceiver and said I/O transceiver comprise wireless transceivers.

28. An operator-controllable observation system according to claim 2, wherein said observation assembly transceiver and said I/O transceiver communicate via an optical fiber.

29. An operator-controllable observation system comprising:
at least one observation assembly including:
a housing having a generally ellipsoidal configuration with a flat base surface;
an imaging subassembly including at least one lens coupled to at least one imaging sensor;
control and processing circuitry operative to process outputs of said imaging subassembly; and
an observation assembly transceiver operative to receive outputs from said control and processing circuitry and to transmit said outputs from said control and processing circuitry; and
at least one control and display assembly including:
an input module, operative to allow said operator to provide operator inputs to said observation assembly;
an output module operative to provide said outputs from said control and processing circuitry to said operator; and
an I/O transceiver operative to communicate with said observation assembly transceiver.

30. An operator-controllable observation system according to claim 29, wherein;
said at least one observation assembly comprises a plurality of observation assemblies;
said at least one control and display assembly comprises a single control and display assembly; and
each of said plurality of observation assemblies is operative to communicate with said single control and display assembly.

31. An operator-controllable observation system according to claim 30, wherein at least one of said plurality of observation assemblies is also operative to communicate with at least one other of said plurality of observation assemblies via a network.

32. An operator-controllable observation system according to claim 30, wherein said single control and display assembly comprises processing circuitry operative to combine image outputs of said plurality of observation assemblies and to provide a combined representation of an operating environment of said plurality of observation assemblies to said operator.

33. An operator-controllable observation system according to claim 32, wherein said processing circuitry is operative to combine said image outputs of said plurality of observation assemblies by layering fields of said image outputs.

34. An operator-controllable observation system according to claim 32, wherein said processing circuitry is operative to combine said image outputs of said plurality of observation assemblies by layering frames of said image outputs.

35. An operator-controllable observation system according to claim 29, wherein;
said at least one observation assembly comprises at least one observation assembly;
said at least one control and display assembly comprises a plurality of control and display assemblies; and
said at least one observation assembly is operative to communicate with each of said plurality of control and display assemblies, thereby relaying data between said plurality of control and display assemblies.

36. An operator-controllable observation system according to claim 2, said system including a plurality of observation assemblies and wherein said control and display assembly comprises processing circuitry operative to combine image outputs of said plurality of observation assemblies and to provide a combined representation of an operating environment of said plurality of observation assemblies to said operator.
